(19) United States
(12) Patent Application Publication
(10) Pub. No.: US 2026/0052159 A1
(43) Pub. Date: Feb. 19, 2026

(54) INTRUSION PREVENTION SYSTEM

(71) Applicant: British Telecommunications Public Limited Company, London Greater London (GB)

(72) Inventors: Syed Muhammad Unsub ZIA, London Greater London (GB); Jamshed MEMON, London Greater London (GB); Mamun ABU-TAIR, London Greater London (GB); Joseph RAFFERTY, London Greater London (GB); Nektarios GEORGALAS, London Greater London (GB)

(21) Appl. No.: 19/103,366

(22) PCT Filed: Aug. 3, 2023
(86) PCT No.: PCT/EP2023/071604

§ 371 Date: Feb. 12, 2025

(30) Foreign Application Priority Data
Aug. 19, 2022 (EP) 22191263.7
Aug. 19, 2022 (GB) 2212114.9

(51) Int. Cl. H04L 9/40; H04W 12/08

(52) U.S. Cl. CPC H04L 63/1408; H04L 63/1441; H04W 12/08

(57) ABSTRACT

An intrusion prevention system, computer-implemented method, computer system and computer program for protecting a network are provided. The system comprises one or more intrusion detection systems. The system further comprises a packet analyser for routing packets within the network that are received from another work. The packet analyser is configured to: receive a packet destined for a computer system within the network; extract one or more features relating to the packet; use a classification model to determine whether the packet is malicious based on the extracted features; prevent delivery of the packet to the computer system in response to determining that the packet is malicious; and deliver the packet to at least one of the intrusion detection systems in the absence of a determination that the packet is malicious. The one or more intrusion detection systems are configured to provide a notification to the packet analyser of any packets that they determine to be malicious. The packet analyser is further configured to train the classification model based on the notification from the one or more intrusion detection systems.

### FIELD OF THE INVENTION

The present invention relates to network security. In particular, the present invention relates to an intrusion prevention system for protecting computer networks.

### BACKGROUND TO THE INVENTION

Firewalls are commonly used within a network to permit or deny traffic flowing into or out of a network (or portion of a network) based on a set of rules. If an appropriate set of rules is defined, the firewall should block all malicious traffic whilst allowing all benign traffic to pass through unhindered. However, it can be tricky to know whether a firewall's rules are sufficient to prevent all possible threats that a network may face. This is particularly true given the fact that the types of threats networks face are ever increasing and can involve new, previously unidentified, attack vectors. Modern firewalls therefore typically also include functionality to allow intrusions into the network to be detected. A system that is capable of performing such detection is commonly referred to as Intrusion Detection System (IDS). Standalone IDSs have also been created that are separate from firewalls (i.e. which do not comprise functionality for blocking or allowing network traffic based on a set of predefined rules). An IDS can detect malicious activity occurring within a network that is indicative of an intrusion being made into the network (e.g. malicious traffic that was not blocked by a firewall's rules). Some IDS's actively prevent (or mitigate) any malicious activity, from impacting the operation of the network or the computer systems within it (e.g. by taking appropriate preventative or mitigating actions to counter the threat posed by the malicious activity). Such systems may be referred to as Intrusion Prevention Systems (IPS).

Intrusion detection systems (and intrusion prevent systems) can generally be divided into host-based systems and network-based systems. As their name suggests, host-based intrusion detection (or prevention) systems are located on the computer systems within the network. These computer systems are typically not dedicated to the purpose of carrying out intrusion detection (or prevention) and instead provide other functionality (such as being used a workstation or server). Host-based intrusion detection (or prevention) systems typically only provide detection (or prevention) for the system on which they operate. Meanwhile, network-based intrusion detection (or prevention) systems are typically located on a dedicated computer system(s) within the network. That is to say, the computer system(s) on which network-based intrusion detection (or prevention) is performed are usually dedicated to the purpose of carrying out intrusion detection (or prevention). Network-based intrusion detection (or prevention) systems typically provide detection (or prevention) for a large number of computer systems, such as an entire network, or a portion thereof. This is typically achieved by monitoring the network traffic flowing to and from those computer systems.

The different types of IDS and IPS can also be distinguished based on the technique that they use to detect threats. One technique that may be used is signature-based detection. This technique uses a set of threat signatures to detect any threats. Each threat signature allows a particular threat to be detected based either upon properties of the network traffic (e.g. the malicious packets associated with the threat) or upon the effects that result on a computer system (e.g. a pattern of file access or modification of specific system files in specific ways), or a combination of both. When using signature-based detection, an IDS and IPS can periodically evaluate recently received packets and/or system activity against a set of threat signatures to determine whether any of the threat signatures matches the recently received packets and/or system activity. If there is a match with one or more of the threat signatures in the set, then the threat associated with those signatures is considered to have been detected and appropriate action may be taken. Signature-based detection relies upon advance knowledge of the threat. That is to say, the threat needs to be a known threat (rather than an previously unknown, or zero-day, threat) so that appropriate threat signatures can be created and provided to the IDSs (or IPSs). Accordingly, such systems may not be able to detect new, previously unknown, threats.

An alternative technique is anomaly-based detection. This technique involves learning the normal behaviour of a computer system and/or flows of network traffic and using this knowledge to detect behaviour and/or network traffic that is not-normal (i.e. anomalous). Since this detection technique does not depend on advanced knowledge of a particular threat to be detected, it can detect previously unknown (or zero-day) threats. However, there is also more of a risk of false alerts being generated when a systems behaviour deviates from normal for entirely benign reasons.

Host-based systems may have an advantage over network-based systems in that the detection of a threat can be based on the resultant behaviour caused in an affected computer system, possibly in addition to the network traffic associated with the threat, whereas network-based systems are typically only able to base their detection on the network traffic. However, in general, it is preferable to take action to prevent or mitigate a threat at the earliest possible opportunity. Therefore, network-based systems (such as those incorporated in a firewall) may be preferable as they can prevent malicious network traffic from reaching network hosts (or even entering the network).

### SUMMARY OF THE INVENTION

In a first aspect of the invention, there is provided an intrusion prevention system for protecting a network, the system comprising: one or more intrusion detection systems; and a packet analyser for routing packets within the network that are received from another network, the packet analyser being configured to: receive a packet destined for a computer system within the network; extract one or more features relating to the packet; use a classification model to determine whether the packet is malicious based on the extracted features; prevent delivery of the packet to the computer system in response to determining that the packet is malicious; and deliver the packet to at least one of the intrusion detection systems in the absence of a determination that the packet is malicious, wherein the one or more intrusion detection systems are configured to provide a notification to the packet analyser of any packets that they determine to be malicious and the packet analyser is further configured to train the classification model based on the notification from the one or more intrusion detection systems.

The invention accordingly provides a hybrid intrusion prevention system. In particular, the packet analyser learns to route packets based on feedback from one or more intrusion detection systems. As a result, the system initially operates predominantly as an intrusion detection system but shifts to operating more as an intrusion prevention system over time as it learns how to classify packets. The system can continue adapting in response to changes to the Intrusion Detection Systems (such as when new threat signatures are provided).

The packet analyser may be further configured to deliver the packet to the computer system in the absence of a determination that the packet is malicious.

The system may comprise a plurality of intrusion detection systems. Each of the plurality of intrusion detection systems may be configured to detect malicious packets based on a respective set of threat signatures and the respective set of threat signatures associated with each intrusion detection system is different. The threat signatures contained in each set of threat signatures may all be associated with a specific class of attack. All of the threat signatures associated with each specific class of attack may be contained in the same set of threat signatures. The threat signatures may be respectively associated with one of one or more, or all, of the following classes of attack: fuzzing attacks; analysis attacks; backdoor attacks; denial of service attacks; exploit attacks; generic attacks; reconnaissance attacks; shellcode attacks; and worm attacks.

The packet analyser may be further configured to use the classification model to determine whether the packet is benign based on the extracted features, wherein the packet may be delivered to the at least one of the intrusion detection systems in the absence of a determination that the packet is benign.

The system may be further configured to prevent delivery of the packet to the computer system in response to a determination by any of the at least one of the intrusion detection systems that the packet is malicious.

The one or more intrusion detection systems may be host-based intrusion detection systems. The at least one of the intrusion detection systems to which the packet is delivered in the absence of a determination that the packet is malicious may be hosted on the computer system to which the packet is destined.

By utilising multiple intrusion detection systems, the workload for detecting threats can be split, which can result in improved system performance.

The use of host-based intrusion detection systems not only means that existing resources can be used in the provision of the hybrid intrusion prevention system, but also allows the system to learn to prevent threats based on detecting those threats through their impact on the behaviour of a computer system (as opposed to basing the detection solely on the network properties themselves). Where a packet is delivered to multiple intrusion detection systems for assessment, those intrusion detection systems may be hosted on different types or configurations of computing device.

In a second aspect of the invention, there is provided a computer implemented method for protecting a network performed by a packet analyser that is configured to route packets within the network that are received from another network, the method comprising: receiving a packet destined for a computer system within the network; extracting one or more features relating to the packet; using a classification model to determine whether the packet is malicious based on the extracted features; preventing delivery of the packet to the computer system in response to determining that the packet is malicious; delivering the packet to at least one intrusion detection system in the absence of a determination that the packet is malicious; and in response to a notification from the at least one intrusion detection system that the packet is malicious, training the classification model based on the notification.

The method may further comprise delivering the packet to the computer system in the absence of a determination that the packet is malicious.

The packet may be delivered to a plurality of intrusion detection systems in the absence of a determination that the packet is malicious.

The method may further comprise using the classification model to determine whether the packet is benign based on the extracted features, wherein the packet is delivered to the at least one of the intrusion detection systems in the absence of a determination that the packet is benign.

The method may further comprise preventing delivery of the packet to the computer system in response to receiving a notification from the at least one intrusion detection system that the packet is malicious.

The at least one intrusion detection system may be a host-based intrusion detection system.

The intrusion detection system to which the packet is delivered in the absence of a determination that the packet is malicious may be hosted on the computer system to which the packet is destined.

In a third aspect of the invention, there is provided a computer system comprising a processor and a memory storing computer program code for performing the method set out above.

In a fourth aspect of the invention, there is provided a computer program which, when executed by one or more processors, is arranged to carry out the method set out above.

### BRIEF DESCRIPTION OF THE FIGURES

Embodiments of the present invention will now be described by way of example only, with reference to the accompanying drawings, in which:

FIG. 1 is a block diagram of a computer system suitable for the operation of embodiments of the present invention.

FIG. 2 is a block diagram of an intrusion prevention system for protecting a network according to embodiments of the invention.

FIG. 3 is a flowchart illustrating a method for protecting a network as performed by the packet analyser according to embodiments of the invention.

FIG. 4 is a flowchart illustrating a method for training the classification model as is performed by the packet analyser according to embodiments of the invention.

### DETAILED DESCRIPTION OF EMBODIMENTS

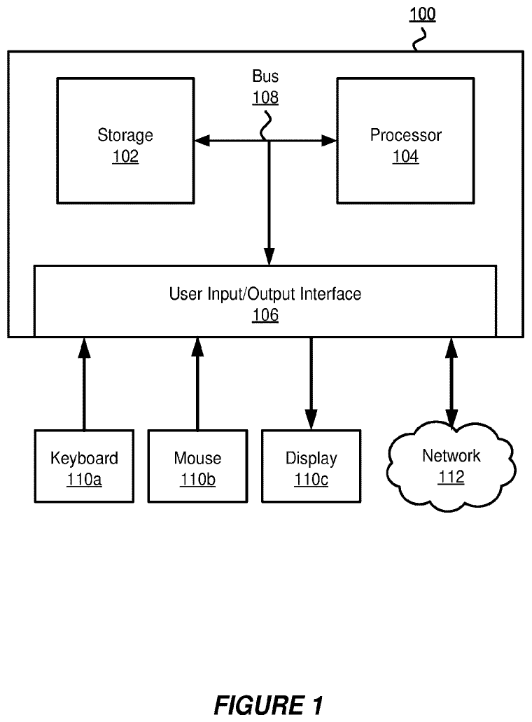

FIG. 1 is a block diagram of a computer system 100 suitable for the operation of embodiments of the present invention. The system 100 comprises: a storage 102, a processor 104 and an input/output (I/O) interface 106, which are all communicatively linked over one or more communication buses 108.

The storage (or storage medium or memory) 102 can be any volatile read/write storage device such as a random access memory (RAM) or a non-volatile storage device such as a hard disk drive, magnetic disc, optical disc, ROM and so on. The storage 102 can be formed as a hierarchy of a plurality of different storage devices, including both volatile and non-volatile storage devices, with the different storage devices in the hierarchy providing differing capacities and response times, as is well known in the art.

The processor 104 may be any processing unit, such as a central processing unit (CPU), which is suitable for executing one or more computer programs (or software or instructions or code). These computer programs may be stored in the storage 102. During operation of the system, the computer programs may be provided from the storage 102 to the processor 104 via the one or more buses 108 for execution. One or more of the stored computer programs, when executed by the processor 104, cause the processor 104 to carry out a method according to an embodiment of the invention, as discussed below (and accordingly configure the system 100 to be a system 100 according to an embodiment of the invention).

The input/output (I/O) interface 106 provides interfaces to devices 110 for the input or output of data, or for both the input and output of data. The devices 110 may include user input interfaces, such as a keyboard 110a or mouse 110b as well as user output interfaces such as a display 110c. Other devices, such a touch screen monitor (not shown) may provide means for both inputting and outputting data. The input/output (I/O) interface 106 may additionally or alternatively enable the computer system 100 to communicate with other computer systems via one or more networks 112. It will be appreciated that there are many different types of I/O interface that may be used with computer system 100 and that, in some cases, computer system 100 may include more than one I/O interface. Furthermore, there are many different types of device 100 that may be used with computer system 100. The devices 110 that interface with the computer system 100 may vary considerably depending on the nature of the computer system 100 and may include devices not explicitly mentioned above, as would be apparent to the skilled person. For example, in some cases, computer system 100 may be a server without any connected user input/output devices. Such a server may receive data via a network 112, carry out processing according to the received data and provide the results of the processing via a network 112.

It will be appreciated that the architecture of the system 100 illustrated in FIG. 1 and described above is merely exemplary and that other computer systems 100 with different architectures (such as those having fewer components, additional components and/or alternative components to those shown in FIG. 1) may be used in embodiments of the invention. As examples, the computer system 100 could comprise one or more of: a personal computer; a laptop; a tablet; a mobile telephone (or smartphone); a television set (or set top box); a games console; an augmented/virtual reality headset; a server; or indeed any other computing device with sufficient computing resources to carry out a method according to embodiments of this invention.

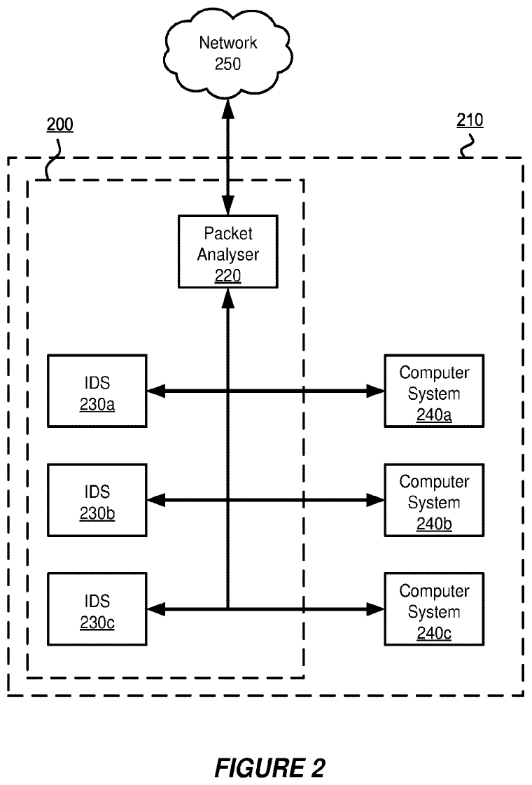

FIG. 2 is a block diagram of an intrusion prevention system 200 for protecting a network 210 according to embodiments of the invention. The system 200 comprises a packet analyser 220 and one or more intrusion detection systems 230.

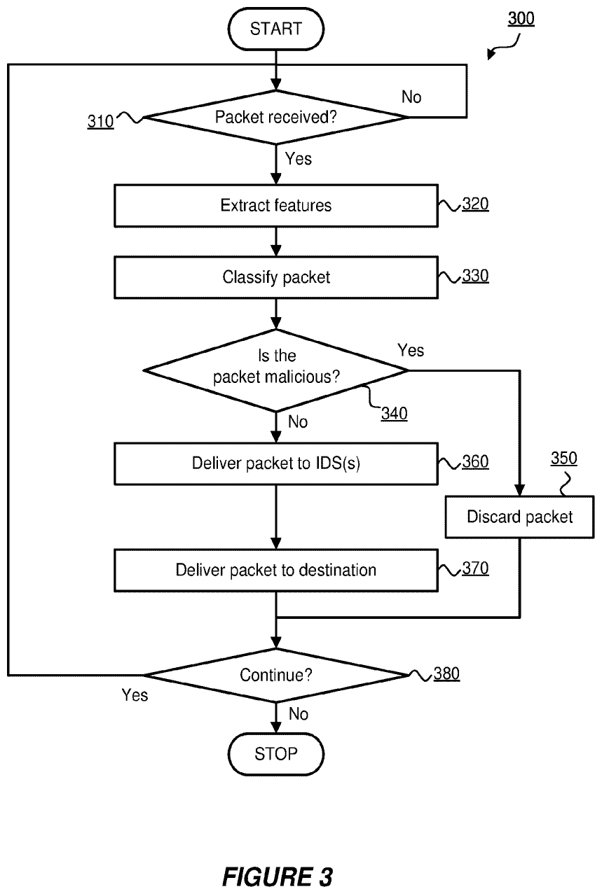

The packet analyser 220 is configured to route packets within the network 200 that are received from another network 250. That is the packet analyser 220 is configured to receive packets from the other network 250 that are destined (or intended) for one or more computer systems 240 within the network 210 that is being protected. The packet analyser makes use of a classification model in determining how packets should be handled, as will be described in more detail below with reference to FIG. 3.

FIG. 3 is a flowchart illustrating a method 300 for protecting a network as performed by the packet analyser 220 according to embodiments of the invention. The method 300 starts with an operation 310.

At operation 310, the method 300 waits for a packet to be received from the other network 250 that is destined for a computer system 240 within the network 210. Once a packet has been received, the method 300 proceeds to an operation 320.

At operation 320, the method 300 extracts one or more features relating to the packet. These features provide a description of the packet and are the basis upon which the classification model obtains a classification of the packet. As an example, the features that are extracted may include one or more of the features set out in the paper “UNSW-NB15: A Comprehensive Data set for Network Intrusion Detection Systems” by Moustafa et al published in 2015 Military Communications and Information Systems Conference (MilCIS) on 10-12 Nov. 2015-particularly in Tables I, II, III, IV, V and VI of that paper.

However, it will be appreciated that any other suitable features that can aid a classifier of an IDS to classify a packet as being either malicious or benign may be used instead or addition to these examples. Accordingly, at operation 320, the method 300 analyses the packet to determine a respective value for each of the features that are to be extracted. The values for these features are then provided as an input to the classification model. Having extracted the features for the packet, the method 300 proceeds to an operation 330.

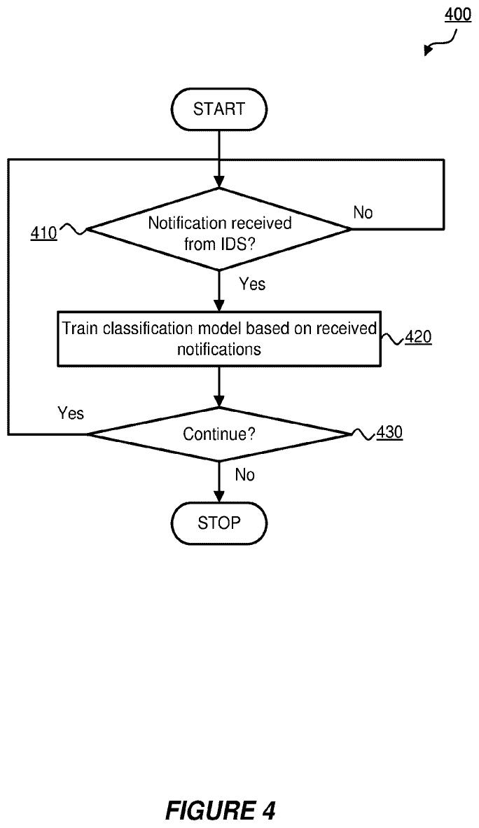

At operation 330, the method 300 uses the classification model to classify the packet based on the extracted features. That is to say, the method 300 provides the values for each of the features that were determined from the received packet at operation 320 as an input to the classification model and obtains a classification of the packet as an output from the model. The classification provided by the model indicates whether the packet is malicious or benign. In other words, the classification model is configured to classify packets into a plurality of classes, whereby one or more of the classes are indicative of malicious packets and one or more of the classes are indicative of benign packets. As will be appreciated, in some cases, the classification model may be trained to classify packets into multiple ‘malicious’ classes, whereby each ‘malicious’ class is associated with a different type of ‘malicious’ packet (e.g. a different type or class of threat). Similarly, in some cases, the classification model may be trained to classify packets into multiple ‘benign’ classes, whereby each ‘benign’ class is associated with a different type of ‘benign’ packet (e.g. with different types of normal data traffic). However, in the simplest case, the classification model produces a binary classification of the packet as being either ‘benign’ or ‘malicious’. The training of the classification model will be discussed further below in association with FIG. 4. Having obtained a classification of the packet from the classification model, the method 300 proceeds to an operation 340.

At operation 340, the method 300 uses the classification obtained from the classification model to determine whether the packet is malicious or not (as indicated by the classification). If the packet is determined to be malicious, the method 300 proceeds to an operation 350. Otherwise, in the absence of a determination that the packet is malicious, the method 300 proceeds to an operation 360.

It will be appreciated that the absence of a positive determination that the packet is malicious is not necessarily the same as determining that the packet is benign. In particular, the absence of a positive determination that the packet is malicious may encompass situations where the classifier is unable to determine whether the packet is malicious or benign with any degree of confidence (i.e. the classification may be indeterminate). For example, as will be familiar to those skilled in the art, the classification model may provide a measure of its confidence in the classification and that confidence may be compared to a predetermined threshold. Where the measure of confidence for a classification of a packet as being malicious exceeds the predetermined threshold, that packet may be determined to be malicious.

In some cases, the method 300 may additionally determine whether the packet is benign at operation 340. That is to say, there may be three possible outcomes from the determination at operation 340, namely: (1) a determination that the packet is malicious; (2) a determination that the packet is benign; and (3) an absence of a determination that the packet is either benign or malicious (i.e. the correct determination for the packet is unknown). In such cases, when it is determined that the packet is malicious, the method 300 proceeds to an operation 350. However, when it is determined that the packet is benign, the method 300 may omit operation 360 and proceed directly to an operation 370. In the absence of a positive determination that the packet is either benign or malicious, the method 300 may proceed to operation 360.

Again, it will be appreciated that the classification model may provide a measure of its confidence in the classification that it produces and this confidence may be compared to a predetermined threshold in order to determine whether the packet is benign. Where the confidence for a classification of a packet as being benign exceeds the predetermined threshold, that packet may be determined to be benign. Otherwise, if the measure of confidence is below the predetermined threshold, the packet may be determined to be non-benign.

In some cases, the classification model may be configured to provide a probability that the packet belongs to each of the possible classifications. In such cases, the classification of the packet may be considered to be ‘unknown’ (i.e. non-malicious, but also non-benign) unless the probability of belonging to at least one of the classes exceeds a predetermined threshold. Additionally or alternatively, the classification of the packet may be considered to be ‘unknown’ unless there is a sufficient distinction between the most likely ‘benign’ classification and the most likely ‘malicious’ classification. That is to say, the classification may be considered to be ‘unknown’ if a magnitude of the difference between the probability of the packet belonging to the most likely ‘benign’ classification and the probability of the packet belonging to the most likely ‘malicious’ classification is less than a predetermined threshold.

Different thresholds may be used for determining that a packet is benign than are used to determine that a packet is malicious. For example, a higher predetermined threshold may be used when determining that a packet is benign than when determining that a packet is malicious, meaning that a greater degree of confidence is required of the classification model to classify a packet as ‘benign’ than to classify a packet as ‘benign’.

At operation 350, which is performed in response to a determination that the packet is malicious at operation 340, the method 300 discards the packet. That is to say, it prevents the packet from being delivered to the computer system for which it was intended. In some cases the method 300 may take one or more further predetermined actions in response to determining that the packet is malicious. These predetermined actions may include any suitable actions taken in response to the detection of a threat to the network as will be apparent to the skilled person. For example, the method 300 may log the packet and/or provide a notification that a malicious packet has been received (and blocked). In any case, having prevented the malicious packet from being delivered, the method 300 proceeds to an operation 380, which will be discussed further below.

At operation 360, which is performed in the absence of a determination that the packet is malicious at operation 340, the method 300 delivers the packet to at least one of the IDSs 230. In some cases, the system 200 may comprise a single intrusion detection system 230, in which case the packet is delivered to that intrusion detection system 230. However, in most cases, the system 200 will comprise a plurality of intrusion detection systems 230.

For example, the intrusion detection system(s) 230 may comprise one or more host-based intrusion detection systems. As already discussed, such IDSs are hosted on computer systems (such as workstations) within the network that are not dedicated to the task of intrusion detection. Accordingly, each IDS may be associated with a respective computer system 240 within the network 200 to which traffic may be addressed. For example, in the exemplary system 200 illustrated in FIG. 2, a first IDS 230a may be hosted on a first computer system 240a, a second IDS 230b may be hosted on a second computer system 240b, a third IDS 230c may be hosted on a second computer system 240c, and so on.

Of course, other types of intrusion detection system, such as network-based intrusion detection systems may be used in addition or as an alternative to host-based intrusion detection systems.

Where the system 200 comprises a plurality of host-based intrusion detection systems 230, the IDS 230 that is hosted by the computer system 240 to which the packet is intended to be delivered may be one of the IDSs to which the packet is delivered.

The intrusion detection systems 230 used within the system 200 may utilise signature-based detection, anomaly-based detection, or both. Where signature-based detection is used, each of the intrusion detection systems 230 is provided with its own set of threat signatures with which to detect malicious packets. These set of threat signatures may be different for each of the intrusion detection systems. Indeed, in some cases, the system 200 may be arranged such that the available threat signatures are divided amongst the intrusion detection systems 230. This can enable the performance of the system 200 to be improved as a packet may be evaluated by multiple IDSs 230 in parallel, each reviewing it against a particular set of threat signatures.

For example, the threat signatures may be divided such that the signatures contained in any given set of threat signatures are all associated with a specific class of attack. That is to say, each of the IDSs may have a set of threat signatures that is tailored towards detecting a specific class of attack. As examples, each set of threat signatures may be associated with detecting one of fuzzing attacks, analysis attacks, backdoor attacks, denial of service attacks, exploit attacks, generic attacks, reconnaissance attacks, shellcode attacks and worm attacks, although other appropriate taxonomies for classifying attacks may be used instead. In some cases, each class of attack may only be detected by a single IDS. That is to say, all of the threat signatures associated with a particular one of these classes of attack may be provided to a single IDS. However, in other cases, multiple IDSs may be able to detect a particular class of attack (albeit, potentially, based on a different set of threat signatures).

In such cases, the classifier used by the packet analyser 220 may be used to predict the most likely class or classes of attack for each packet. The packet may then be delivered to those IDSs having threat signatures that are associated with the predicted classes of attack. For example, the classification model may have an output class associated with each class of attack and may provide an indication of the likelihood that a given packet belongs to a particular class of attack. These indications may be used to identify those classes of attack that are most likely, such as by choosing a predetermined number of classes of attack having the highest likelihoods, or by choosing any classes of attack where the indicated likelihood is above a predetermined threshold (but below any threshold that would allow the packet analyser to determine positively that the packet is malicious). The packet may then be forwarded to any IDSs that are tailored towards detecting those classes of attack (i.e. which have threat signatures for detecting those classes of attack).

In any case, having delivered the packet to at least one of the IDSs 230, the method 300 proceeds to an operation 370.

At operation 370, the method 300 delivers the packet to its destination. That is to say, the method 300 delivers the packet to the computer system 240 to which it was intended to be delivered. In some cases, the packet may be delivered to the computer system 240 by one of the IDS 230 to which the packet was delivered in operation 360. For example, the packet may be delivered by a host-based IDS that is hosted on that computer system 240. In other cases, the packet may be delivered to the computer system 240 in parallel to the one or more IDSs 230 to which it is also delivered. In any case, having delivered the packet to the intended computer system 240, the method 300 proceeds to operation 380.

At operation 380, the method 300 determines whether to continue processing. That is to say, whether to carry out a further iteration of the method 300 in respect of a further packet. If so, the method 300 returns to operation 310 to repeat operations 310-380. Otherwise, the method ends. As will be appreciated by those skilled in the art, it is generally expected (but not necessary) that the method will be performed on a continuous basis so as to provide an Intrusion Prevention Service for the network 210. In such cases, the method 300 may be performed iteratively until a shutdown or stop signal is received. Similarly, multiple instances of method 300 may be run in parallel (or at least substantially in parallel) such that multiple packets can be analysed and handled simultaneously (or at least substantially simultaneously).

FIG. 4 is a flowchart illustrating a method 400 for training the classification model as is performed by the packet analyser 220 according to embodiments of the invention.

At operation 410, the method 400 receives a notification from one or more of the intrusion detection systems 230 indicating that a packet that was delivered to them (i.e. during the performance of operation 370 in respect of that packet) is considered to be malicious. That is to say, the one or more intrusion detection systems 230 are configured such that, upon receipt of a packet from the packet analyser, they analyse the packet (and/or its actions on a computer system associated with that intrusion detection system 230) in order to detect any malicious activity. In response to the detection of a malicious packet, the intrusion detection systems 230 are configured to notify the packet analyser 220 that the packet was malicious. Of course, in some cases the intrusion detection system may take further action to prevent or mitigate the impact of the threat presented by a malicious packet, as will be appreciated by those skilled in the art (in which case the intrusion detection system 230 may instead be referred to as an intrusion prevention systems). Having received a notification about malicious packets from one or more of the intrusion detection systems 230, the method proceeds to an operation 420.

At operation 420, the method 400 trains (or retrains) the classification model based on the received notification(s). Specifically, the method 400 adds the packets for which notification(s) were received as labelled samples to a body of training data and uses that training data to train the classification model according to a supervised machine learning algorithm. As examples, the classification model may be trained using any of the following algorithms: neural networks, linear classifiers, support vector machines, decision trees, k-nearest neighbour, and random forest. However, it will be appreciated these are merely provided as examples and that any suitable supervised machine learning algorithm which is capable of training a classification model based on the feedback from the one or more intrusion detection systems 230 may be used.

At operation 430, the method 400 determines whether to continue processing. That is to say, whether to carry out a further iteration of method 400 to retrain the classification model using further notifications from the intrusion detection systems 230. If so, the method 400 returns to operation 410 to repeat operations 410-430. Otherwise, the method 400 ends. As will be appreciated by those skilled in the art, it is generally expected (but not necessary) that the method will be performed on a continuous, periodic or sporadic basis, so as update the classification model over time. For example, the method 400 may be repeated whenever a new notification is received from an intrusion detection system 230. Alternatively, the method 400 may wait for a predetermined period of time to elapse since the completion of one iteration before performing the next iteration, which all notifications received during that time being used to retrain the classification model. As another example, the method 400 may wait for a predetermined number of new notifications to be received from the intrusion detection systems 230 before performing another iteration. Similarly, this approaches may be combined. For example, the next iteration may be performed once either a predetermined number of new notifications have been received or a predetermined period of time has elapsed since the previous iteration was performed, whichever occurs first. Alternatively, the next iteration may only be performed once both a predetermined number of new notifications have been received and a predetermined period of time has elapsed. In such cases, where the method 400 may be performed iteratively until a shutdown or stop signal is received.

Accordingly, as described above, the system 200 provides a hybrid intrusion detection and prevention system for protecting a network 210. Initially, prior to any training taking place, the packet analyser 220 may simply forward all packets to the intrusion detection systems 230 such that the system 200 operates in a predominantly as an intrusion detection system. However, over time, as it learns from the intrusion detection systems 230, the packet analyser can increasingly prevent malicious packets from being delivered and so functions more like an intrusion prevention system. Accordingly, the amount of processing required from the intrusion detection systems 230 will also reduce over time. Furthermore, the classification model upon which the packet analyser functions may be shared between networks, meaning that learning that took place in one network can readily be supplanted into another network.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example. Suitably, the computer program is stored on a carrier medium in machine or device readable form, for example in solid-state memory, magnetic memory such as disk or tape, optically or magneto-optically readable memory such as compact disk or digital versatile disk etc., and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention. It will be understood by those skilled in the art that, although the present invention has been described in relation to the above-described example embodiments, the invention is not limited thereto and that there are many possible variations and modifications which fall within the scope of the invention. The scope of the present invention includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. An intrusion prevention system for protecting a network, the system comprising:
one or more intrusion detection systems; and
a packet analyser for routing packets within the network that are received from another network, the packet analyser being configured to:
receive a packet destined for a computer system within the network;
extract one or more features relating to the packet;
use a classification model to determine whether the packet is malicious based on the extracted features;
prevent delivery of the packet to the computer system in response to determining that the packet is malicious; and
deliver the packet to at least one of the intrusion detection systems in the absence of a determination that the packet is malicious,
wherein the one or more intrusion detection systems are configured to provide a notification to the packet analyser of any packets that they determine to be malicious and the packet analyser is further configured to train the classification model based on the notification from the one or more intrusion detection systems.

2. The system of claim 1, wherein the packet analyser is further configured to deliver the packet to the computer system in the absence of a determination that the packet is malicious.

3. The system of claim 1, comprising a plurality of intrusion detection systems.

4. The system of claim 3, wherein each of the plurality of intrusion detection systems is configured to detect malicious packets based on a respective set of threat signatures and the respective set of threat signatures associated with each intrusion detection system is different.

5. The system of claim 4, wherein the threat signatures contained in each set of threat signatures are all associated with a specific class of attack.

6. The system of claim 4, wherein all of the threat signatures associated with each specific class of attack are contained in the same set of threat signatures.

7. The system of claim 4, wherein the threat signatures are respectively associated with one of one or more, or all, of the following classes of attack:
fuzzing attacks;
analysis attacks;
backdoor attacks;
denial of service attacks;
exploit attacks;
generic attacks;
reconnaissance attacks;
shellcode attacks; and
worm attacks.

8. The system of claim 1, wherein the packet analyser is further configured to use the classification model to determine whether the packet is benign based on the extracted features, wherein the packet is delivered to the at least one of the intrusion detection systems in the absence of a determination that the packet is benign.

9. The system of claim 1, wherein the system is further configured to prevent delivery of the packet to the computer system in response to a determination by any of the at least one of the intrusion detection systems that the packet is malicious.

10. The system of claim 1, wherein the one or more intrusion detection systems are host-based intrusion detection systems.

11. The system of claim 10, wherein the at least one of the intrusion detection systems to which the packet is delivered in the absence of a determination that the packet is malicious is hosted on the computer system to which the packet is destined.

12. A computer implemented method for protecting a network performed by a packet analyser that is configured to route packets within the network that are received from another network, the method comprising:
receiving a packet destined for a computer system within the network;
extracting one or more features relating to the packet;
using a classification model to determine whether the packet is malicious based on the extracted features;
preventing delivery of the packet to the computer system in response to determining that the packet is malicious;
delivering the packet to at least one intrusion detection system in the absence of a determination that the packet is malicious; and
in response to a notification from the at least one intrusion detection system that the packet is malicious, training the classification model based on the notification.

13. The method of claim 12, further comprising delivering the packet to the computer system in the absence of a determination that the packet is malicious.

14. The method of claim 12, wherein the packet is delivered to a plurality of intrusion detection systems in the absence of a determination that the packet is malicious.

15. The method of claim 12, further comprising using the classification model to determine whether the packet is benign based on the extracted features, wherein the packet is delivered to the at least one of the intrusion detection systems in the absence of a determination that the packet is benign.

16. The method of claim 12, further comprising preventing delivery of the packet to the computer system in response to receiving a notification from the at least one intrusion detection system that the packet is malicious.

17. The method of claim 12, wherein the at least one intrusion detection system is a host-based intrusion detection system.

18. The method of claim 17, wherein the intrusion detection system to which the packet is delivered in the absence of a determination that the packet is malicious is hosted on the computer system to which the packet is destined.

19. A computer system comprising a processor and a memory storing computer program code for performing the steps of claim 13.

20. A computer program which, when executed by one or more processors, is arranged to carry out a method according to claim 13.
